(19) United States
(12) Patent Application Publication
(10) Pub. No.: US 2024/0143583 A1
(43) Pub. Date: May 2, 2024

(54) CHATBOT MODULE FACILITATING INSIGHT EVALUATION AND MULTI-SOURCED RESPONSE GENERATION

(71) Applicant: Sumitomo Pharma Co., Ltd., Osaka (JP)

(72) Inventors: Alan Jeffrey Menaged, Elberon, NJ (US); Elliott Rain Morelli, Brooklyn, NY (US); Daniel Jaebin Park, Cambridge, MA (US); Jonathan William Price, South Elgin, IL (US); Daniel Benjamin Rand, New York, NY (US); Timothy Cao Tran, Orange, CA (US)

(73) Assignee: Sumitomo Pharma Co., Ltd., Osaka (JP)

(21) Appl. No.: 18/486,108

(22) Filed: Oct. 12, 2023

Related U.S. Application Data
(60) Provisional application No. 63/415,961, filed on Oct. 13, 2022.
(60) Provisional application No. 63/588,277, filed on Oct. 5, 2023.

(51) Int. Cl. G06F 16/242; G06F 16/2457; G06F 16/248; G06F 40/232; G06F 40/284; G06F 40/295; H04L 51/02

(52) U.S. Cl. CPC G06F 16/243; G06F 16/2457; G06F 16/248; G06F 40/232; G06F 40/284; G06F 40/295; H04L 51/02

(57) ABSTRACT

A system comprising a client device and a server network, the client device configured to receive a query; transmit the query; receive a populated response; and display the populated response. The server network may be configured to receive the query; tokenize the query; generate an intent-match likelihood for each of a plurality of supported question intents; classify the query based on the intent-match likelihoods; evaluate each of the intent-match likelihoods to a confidence threshold; extract, via a Named Entity Recognition model, one or more entities from the query; determine one or more entity values for each of the one or more entities; query the at least one database to incorporate intent to the one or more entities and the one or more entity values; populate a response template with the one or more entity values and one or more specifics; and store the query and the populated response.

### CROSS-REFERENCE TO RELATED APPLICATIONS

The present application claims the benefit of U.S. Patent Application No. 63/415,961 for SYSTEM FOR A CHATBOT MODULE FACILITATING INSIGHT EVALUATION AND MULTI-SOURCED RESPONSE GENERATION THEREOF, filed Oct. 13, 2022, and U.S. Patent Application No. 63/588,277 for CHATBOT MODULE FACILITATING INSIGHT EVALUATION AND MULTI-SOURCED RESPONSE GENERATION, filed Oct. 5, 2023, the entire contents of which are incorporated herein by reference in their entirety.

### FIELD OF THE INVENTION

The present disclosure relates to interactive computer-implemented tools, such as chatbots. Specifically, the present disclosure relates to systems and methods for facilitating insight evaluation and presentation of responses as derived from multiple data sources.

### INTRODUCTION

A chatbot may be a robot or software aspect configured to receive a textual input from a user and output a tailored and correlated message. Typically, conventional chatbots may be in communication with a singular database comprising preconfigured responses and/or rudimentary fillable templates. Further, many chatbots are insufficient at delivering information in fields where a widespread set of data may be required. For example, chatbots tailored for use by sales representatives may be required to evaluate various data streams comprising product information, client identification, legal details, sales statistics, and other multifaceted datasets. Yet further, many such conventional chatbots fail to provide streamlined responses within a singular interface. Thus, it would be desirable to provide a chatbot configured to evaluate various datasets yet output streamlined responses in a coherent and easily-navigable interface.

Moreover, information passing through a chatbot may provide insights on the user's behavior and the underlying event, such as a pharmaceutical sale. For example, a chatbot for use with a sales team may transmit a vast number of messages, each message containing information with extractable intent and content. Therefore, it would be desirable to provide a chatbot module adapted to evaluate input and output data for meaningful insights. It would be further desirable to provide a chatbot system configured to translate strategic insights into actionable information for sales representative utilization.

In many conventional customer relationship management tools, to access data relating to customers, sales representatives typically resort to a plurality of dashboards. This poses a number of challenges. From the perspective of a sales representative, navigation through a plurality of dashboards makes it very difficult to find the required information, especially when in transit or in the absence of a desktop computer. In such conventional systems, desired information is often distributed across many systems and views. Since such conventional systems require multiple interfaces and dashboards, they are slow to load, and often require many clicks to navigate. From an operations perspective, it is difficult to discern what information a sales representative is viewing across a plurality of dashboards, making it difficult to assess the value and impact of particular insights.

Many conventional chatbots return predetermined strings of unstructured text, preventing seamless analysis of the data embedded within such messages. Thus, it would be desirable to provide a chatbot configured to enable review and/or retention of data extracted from input messages and information generated for outgoing messages.

### SUMMARY

In accordance with the present disclosure, the following items are provided.

(Item 1). A system of networked devices configured to administer operation of a chatbot, the system comprising:
a client device comprising at least one device processor, at least one display, at least one device memory comprising computer-executable device instructions which, when executed by the at least one device processor, cause the client device to:
receive, via a frontend, a query;
transmit, to an engine, the query;
receive, via the engine, a populated response;
display, via the client device, the populated response; and
a server network in bidirectional communication with the client device, the server network comprising at least one server processor, at least one server database, at least one server memory comprising computer-executable server instructions which, when executed by the at least one server processor, cause the server network to:
receive, from the frontend, the query;
tokenize, via the engine, the query;
generate an intent-match likelihood, via the engine, for each of a plurality of supported question intents;
classify, via the engine, the query based on the intent-match likelihoods for each of the plurality of supported question intents;
evaluate, via the engine, each of the intent-match likelihoods to a confidence threshold;
extract, via the engine and a Named Entity Recognition model, one or more entities from the query based on one or more prestored entities;
determine one or more entity values for each of the one or more entities;
query the at least one server database to incorporate intent to the one or more entities and the one or more entity values;
populate, via an action server, a response template with the one or more entity values based on one or more prestored entity values and one or more specifics to form a populated response,
wherein the one or more specifics are correlated to the one or more prestored entity values in the at least one server database via an entity value ID;
store, via a tracker store, the query, the one or more entities, the one or more entity values, the one or more specifics, a user identification, a timestamp, and the populated response based on the intent-match likelihoods and the confidence threshold,
wherein the user identification corresponds to a user who transmitted the query, and
wherein the timestamp corresponds to the frontend's reception of the query; and transmit, to the frontend, the populated response.

(Item 2). The system of networked devices of item 1, further comprising an administrator monitor in electronic communication with the tracker store, wherein the administrator monitor comprises an administrator authentication login, and wherein the administrator monitor is adapted to provide one or more insights derived from the tracker store.

(Item 3). The system of networked devices of any one of items 1-2, the frontend further comprising a chat interface, wherein the chat interface comprises a textual entry tool and a chat body configured to display the populated response.

(Item 4). The system of networked devices of any one of items 1-3, the frontend further comprising a speech to text entry tool, wherein the client device is configured to capture audio.

(Item 5). The system of networked devices of any one of items 1-4, the frontend further comprising a profile interface, wherein the profile interface is accessible via actuation of one or more hyperlinks in the populated response, and wherein the profile interface is correlated to the one or more entity values, and the profile interface comprises one or more of the one or more specifics.

(Item 6). The system of networked devices of any one of items 1-5, wherein the Named Entity Recognition model is trained on a training data set comprising a plurality of chat logs.

(Item 7). The system of networked devices of any one of items 1-6, wherein the Named Entity Recognition model is configured to evaluate the query for one or more errors including typos, punctuation errors, and spelling errors.

(Item 8). The system of networked devices of any one of items 1-7, wherein a Fuzzy matcher is configured to filter the one or more entities and the one or more entity values in view of a predetermined geographical region.

(Item 9). The system of networked devices of any one of items 1-8, the computer-executable server instructions which, when executed by the at least one server processor, cause the server network to generate an image on the network server, wherein the image is passed through to the populated response.

(Item 10). The system of networked devices of any one of items 1-9, the computer-executable server instructions which, when executed by the at least one server processor, cause the server network to:
populate the at least one server database with one or more addresses, each of the one or more addresses correlated to at least one of the one or more prestored entity values;
determine which of the one or more prestored entity values are within a boundary box to build a list of nearby entity values, wherein a center of the boundary box is based on one or more of the one or more entities; and
rank the list of nearby entity values based on distance to one of the one or more entity values.

(Item 11). The system of networked devices of item 10, the computer-executable server instructions which, when executed by the at least one server processor, cause the server network to:
convert each of the one or more addresses to a geographical coordinate format.

(Item 12). The system of networked devices of any one of items 10-11, the computer-executable server instructions which, when executed by the at least one server processor, cause the server network to: generate a nearby entity interface comprising at least the list of nearby entity values.

(Item 13). The system of networked devices of item 12, wherein the nearby entity interface comprises a profile interface button for each of the list of nearby entity values, wherein actuation of the profile interface button generates a profile interface of the nearby entity value.

(Item 14). The system of networked devices of any one of items 1-8 and 10-13, the computer-executable server instructions which, when executed by the at least one server processor, cause the server network to:
classify a set of image-inducing entity values from the one or more prestored entity values;
classify a first subset and a second subset from the set of image-inducing entity values;
generate, via the action server, a first subset image based on each of the first subset;
generate a first subset image link, via an object-based storage, for the first subset image; and
transmit the first subset image link, from the object-based storage to the frontend, if one of the first subset entity values exists within the query.

(Item 15). The system of networked devices of item 14, the computer-executable server instructions which, when executed by the at least one server processor, cause the server network to:
generate, via the frontend, a second subset image if one of the second subset entity values exists within the query.

(Item 16). The system of networked devices of any one of items 1-15, the computer-executable server instructions which, when executed by the at least one server processor, cause the server network to:
classify at least each of the one or more prestored entities stored within the tracker store into a first group or a second group;
delete, via a purge module, in the tracker store, at least the one or more entity values correlated with each of the one or more entities in the first group.

(Item 17). The system of networked devices of item 16, wherein the first group further comprises a first set of information and a second set of information, wherein the first set of information is configured to be purged upon a first interval, and wherein the second set of information is configured to be purged upon a second interval.

(Item 18). The system of networked devices of item 5, wherein the profile interface comprises a product data table comprising a quantity selection tool and a timeframe selection tool, wherein the quantity selection tool is configured to alter the product data table from a total product metric to a new product metric, and wherein the timeframe selection tool is configured to alter the product data table from a first timeframe to a second timeframe.

(Item 19). The system of networked devices of any one of items 5 and 18, wherein the profile interface comprises a payer table comprising a payer selection tool, wherein the payer selection tool is configured to alter the payer table from a first payer to a second payer.

(Item 20). The system of networked devices of any one of items 1-19, the computer-executable server instructions which, when executed by the at least one server processor, cause the server network to:
scrape an external source for one or more publications correlated to at least one of the one or more entity values;
query at least one of the one or more entity values in the query against the one or more publications;
populate an alert template with one or more of the one or more publications correlated to the at least one of the one or more entity values; and
display, via the frontend, a populated alert.

(Item 21). A method for operation of a chatbot, the method comprising the steps of:
receiving, via a frontend, a query;
transmitting, to an engine, the query;
receiving, via the engine, a populated response;
displaying, via a client device, the populated response;
receiving, from the frontend, the query;
tokenizing, via the engine, the query;
generating an intent-match likelihood, via the engine, for each of a plurality of supported question intents;
classifying, via the engine, the query based on the intent-match likelihoods for each of the plurality of supported question intents;
evaluating, via the engine, each of the intent-match likelihoods to a confidence threshold;
extracting, via the engine and a Named Entity Recognition model, one or more entities from the query based on one or more prestored entities;
determining one or more entity values for each of the one or more entities; querying at least one server database to incorporate intent to the one or more entities and the one or more entity values;
populating, via an action server, a response template with the one or more entity values based on one or more prestored entity values and one or more specifics to form a populated response,
wherein the one or more specifics are correlated to the one or more prestored entity values in the at least one server database via an entity value ID;
storing, via a tracker store, the query, the one or more entities, the one or more entity values, the one or more specifics, a user identification, a timestamp, and the populated response based on the intent-match likelihoods and the confidence threshold,
wherein the user identification corresponds to a user who transmitted the query, and
wherein the timestamp corresponds to the frontend's reception of the query; and
transmitting, to the frontend, the populated response.

(Item 22). The method of item 21, further comprising an administrator monitor in electronic communication with the tracker store, wherein the administrator monitor comprises an administrator authentication login, and wherein the administrator monitor is adapted to provide one or more insights derived from the tracker store.

(Item 23). The method of any one of items 21-22, the frontend further comprising a chat interface, wherein the chat interface comprises a textual entry tool and a chat body configured to display the populated response.

(Item 24). The method of any one of items 21-23, the frontend further comprising a speech to text entry tool, wherein the client device is configured to capture audio.

(Item 25). The method of any one of items 21-24, the frontend further comprising a profile interface, wherein the profile interface is accessible via actuation of one or more hyperlinks in the populated response, and wherein the profile interface is correlated to the one or more entity values,
and the profile interface comprises one or more of the one or more specifics.

(Item 26). The method of any one of items 21-25, wherein the Named Entity Recognition model is trained on a training data set comprising a plurality of chat logs.

(Item 27). The method of any one of items 21-26, wherein the Named Entity Recognition model is configured to evaluate the query for one or more errors including typos, punctuation errors, and spelling errors.

(Item 28). The method of any one of items 21-27, wherein a Fuzzy matcher is configured to filter the one or more entities and the one or more entity values in view of a predetermined geographical region.

(Item 29). The method of any one of items 21-28 further comprising the step of generating an image on a network server, wherein the image is passed through to the populated response.

(Item 30). The method of any one of items 21-29 further comprising the steps of: populating the at least one server database with one or more addresses, each of the one or more addresses correlated to at least one of the one or more prestored entity values;
determining which of the one or more prestored entity values are within a boundary box to build a list of nearby entity values, wherein a center of the boundary box is based on one or more of the one or more entities; and
ranking the list of nearby entity values based on distance to one of the one or more entity values.

(Item 31). The method of item 30, further comprising the step of:
converting each of the one or more addresses to a geographical coordinate format.

(Item 32). The method of any one of items 30-31, further comprising the step of:
generating a nearby entity interface comprising at least the list of nearby entity values.

(Item 33). The method of item 32, wherein the nearby entity interface comprises a profile interface button for each of the list of nearby entity values, wherein actuation of the profile interface button generates a profile interface of the nearby entity value.

(Item 34). The method of any one of items 21-28 and 30-33, further comprising the steps of:
classifying a set of image-inducing entity values from the one or more prestored entity values;
classifying a first subset and a second subset from the set of image-inducing entity values;
generating, via the action server, a first subset image based on each of the first subset;
generating a first subset image link, via an object-based storage, for the first subset image; and
transmitting the first subset image link, from the object-based storage to the frontend, if one of the first subset entity values exists within the query.

(Item 35). The method of item 34, further comprising the step of:
generating, via the frontend, a second subset image if one of the second subset entity values exists within the query.

(Item 36). The method of any one of items 21-35, further comprising the steps of:
classifying at least each of the one or more prestored entities stored within the tracker store into a first group or a second group;
deleting, via a purge module, in the tracker store, at least the one or more entity values correlated with each of the one or more entities in the first group.

(Item 37). The method of item 36, wherein the first group further comprises a first set of information and a second set of information, wherein the first set of information is configured to be purged upon a first interval, and wherein the second set of information is configured to be purged upon a second interval.

(Item 38). The method of item 25, wherein the profile interface comprises a product data table comprising a quantity selection tool and a timeframe selection tool, wherein the quantity selection tool is configured to alter the product data table from a total product metric to a new product metric, and wherein the timeframe selection tool is configured to alter the product data table from a first timeframe to a second timeframe.

(Item 39). The method of any one of items 25 and 38, wherein the profile interface comprises a payer table comprising a payer selection tool, wherein the payer selection tool is configured to alter the payer table from a first payer to a second payer.

(Item 40). The method of any one of items 21-39, further comprising the steps of:
scraping an external source for one or more publications correlated to at least one of the one or more entity values;
querying at least one of the one or more entity values in the query against the one or more publications;
populating an alert template with one or more of the one or more publications correlated to the at least one of the one or more entity values; and
displaying, via the frontend, a populated alert.

(Item 41). A non-transitory computer readable medium having instructions stored thereon that, when executed by a processing device, cause the processing device to carry out an operation of chatbot interaction between a server and a client device, the operation comprising:
receiving, via a frontend, a query;
transmitting, to an engine, the query;
receiving, via the engine, a populated response;
displaying, via the client device, the populated response;
receiving, from the frontend, the query;
tokenizing, via the engine, the query;
generating an intent-match likelihood, via the engine, for each of a plurality of supported question intents;
classifying, via the engine, the query based on the intent-match likelihoods for each of the plurality of supported question intents;
evaluating, via the engine, each of the intent-match likelihoods to a confidence threshold;
extracting, via the engine and a Named Entity Recognition model, one or more entities from the query based on one or more prestored entities;
determining one or more entity values for each of the one or more entities;
querying the at least one server database to incorporate intent to the one or more entities and the one or more entity values;
populating, via an action server, a response template with the one or more entity values based on one or more prestored entity values and one or more specifics to form a populated response,
wherein the one or more specifics are correlated to the one or more prestored entity values in the at least one server database via an entity value ID;
storing, via a tracker store, the query, the one or more entities, the one or more entity values, the one or more specifics, a user identification, a timestamp, and the populated response based on the intent-match likelihoods and the confidence threshold,
wherein the user identification corresponds to a user who transmitted the query, and
wherein the timestamp corresponds to the frontend's reception of the query; and
transmitting, to the frontend, the populated response.

(Item 42). The non-transitory computer readable medium of item 41, further comprising an administrator monitor in electronic communication with the tracker store, wherein the administrator monitor comprises an administrator authentication login, and wherein the administrator monitor is adapted to provide one or more insights derived from the tracker store.

(Item 43). The non-transitory computer readable medium of any one of items 41-42, the frontend further comprising a chat interface, wherein the chat interface comprises a textual entry tool and a chat body configured to display the populated response.

(Item 44). The non-transitory computer readable medium of any one of items 41-43, the frontend further comprising a speech to text entry tool, wherein the client device is configured to capture audio.

(Item 45). The non-transitory computer readable medium of any one of items 41-44, the frontend further comprising a profile interface, wherein the profile interface is accessible via actuation of one or more hyperlinks in the populated response, and wherein the profile interface is correlated to the one or more entity values, and the profile interface comprises one or more of the one or more specifics.

(Item 46). The non-transitory computer readable medium of any one of items 41-45, wherein the Named Entity Recognition model is trained on a training data set comprising a plurality of chat logs.

(Item 47). The non-transitory computer readable medium of any one of items 41-46, wherein the Named Entity Recognition model is configured to evaluate the query for one or more errors including typos, punctuation errors, and spelling errors.

(Item 48). The non-transitory computer readable medium of any one of items 41-47, wherein a Fuzzy matcher is configured to filter the one or more entities and the one or more entity values in view of a predetermined geographical region.

(Item 49). The non-transitory computer readable medium of any one of items 41-48, the operation further comprising generating an image on a network server, wherein the image is passed through to the populated response.

(Item 50). The non-transitory computer readable medium of any one of items 41-49, the operation further comprising:
populating the at least one server database with one or more addresses, each of the one or more addresses correlated to at least one of the one or more prestored entity values;
determining which of the one or more prestored entity values are within a boundary box to build a list of nearby entity values, wherein a center of the boundary box is based on one or more of the one or more entities; and
ranking the list of nearby entity values based on distance to one of the one or more entity values.

(Item 51). The non-transitory computer readable medium of item 50, the operation further comprising:
converting each of the one or more addresses to a geographical coordinate format.

(Item 52). The non-transitory computer readable medium of any one of items 50-51, the operation further comprising:
generating a nearby entity interface comprising at least the list of nearby entity values.

(Item 53). The non-transitory computer readable medium of item 52, wherein the nearby entity interface comprises a profile interface button for each of the list of nearby entity values,
wherein actuation of the profile interface button generates a profile interface of the nearby entity value.

(Item 54). The non-transitory computer readable medium of any one of items 41-48 and 50-53, the operation further comprising:
classifying a set of image-inducing entity values from the one or more prestored entity values;
classifying a first subset and a second subset from the set of image-inducing entity values;
generating, via the action server, a first subset image based on each of the first subset;
generating a first subset image link, via an object-based storage, for the first subset image; and
transmitting the first subset image link, from the object-based storage to the frontend, if one of the first subset entity values exists within the query.

(Item 55). The non-transitory computer readable medium of item 54, the operation further comprising:
generating, via the frontend, a second subset image if one of the second subset entity values exists within the query.

(Item 56). The non-transitory computer readable medium of any one of items 41-55, the operation further comprising:
classifying at least each of the one or more prestored entities stored within the tracker store into a first group or a second group;
deleting, via a purge module, in the tracker store, at least the one or more entity values correlated with each of the one or more entities in the first group.

(Item 57). The non-transitory computer readable medium of item 56, wherein the first group further comprises a first set of information and a second set of information, wherein the first set of information is configured to be purged upon a first interval, and wherein the second set of information is configured to be purged upon a second interval.

(Item 58). The non-transitory computer readable medium of item 45, wherein the profile interface comprises a product data table comprising a quantity selection tool and a timeframe selection tool, wherein the quantity selection tool is configured to alter the product data table from a total product metric to a new product metric, and wherein the timeframe selection tool is configured to alter the product data table from a first timeframe to a second timeframe.

(Item 59). The non-transitory computer readable medium of any one of items 45 and 58, wherein the profile interface comprises a payer table comprising a payer selection tool, wherein the payer selection tool is configured to alter the payer table from a first payer to a second payer.

(Item 60). The non-transitory computer readable medium of any one of items 41-59, the operation further comprising:
scraping an external source for one or more publications correlated to at least one of the one or more entity values;
querying at least one of the one or more entity values in the query against the one or more publications;
populating an alert template with one or more of the one or more publications correlated to the at least one of the one or more entity values; and
displaying, via the frontend, a populated alert.

(Item 61). A system of networked devices configured to administer operation of a chatbot, the system comprising:
a client device comprising at least one device processor, at least one display, at least one device memory comprising computer-executable device instructions which, when executed by the at least one device processor, cause the client device to:
receive, via a frontend, a query;
transmit, to an engine, the query;
receive, via the engine, a populated response;
display, via the client device, the populated response; and
a server network in bidirectional communication with the client device, the server network comprising at least one server processor, at least one server database, at least one server memory comprising computer-executable server instructions which, when executed by the at least one server processor, cause the server network to:
receive, from the frontend, the query;
tokenize, via the engine, the query;
generate an intent-match likelihood, via the engine, for each of a plurality of supported question intents;
classify, via the engine, the query based on the intent-match likelihoods for each of the plurality of supported question intents;
evaluate, via the engine, each of the intent-match likelihoods to a confidence threshold;
extract, via the engine and a Named Entity Recognition model, one or more entities from the query based on one or more prestored entities;
determine one or more entity values for each of the one or more entities;
query the at least one server database to incorporate intent to the one or more entities and the one or more entity values;
populate, via an action server, a response template with the one or more entity values based on one or more prestored entity values and one or more specifics to form a populated response,
wherein the one or more specifics are correlated to the one or more prestored entity values in the at least one server database via an entity value ID;
store, via a tracker store, the query, the one or more entities, the one or more entity values, the one or more specifics, a user identification, a timestamp, and the populated response based on the intent-match likelihoods and the confidence threshold,
wherein the user identification corresponds to a user who transmitted the query, and
wherein the timestamp corresponds to the frontend's reception of the query; and
transmit, to the frontend, the populated response, the frontend comprising a profile interface, wherein the profile interface is accessible via actuation of one or more hyperlinks in the populated response, and wherein the profile interface is correlated to the one or more entity values, and the profile interface comprises one or more of the one or more specifics,
wherein the profile interface comprises a product data table comprising a quantity selection tool and a timeframe selection tool, wherein the quantity selection tool is configured to alter the product data table from a total product metric to a new product metric, and wherein the timeframe selection tool is configured to alter the product data table from a first timeframe to a second timeframe, and
wherein the profile interface comprises a payer table comprising a payer selection tool, wherein the payer selection tool is configured to alter the payer table from a first payer category to a second payer category.

(Item 62). A method for operation of a chatbot, the method comprising the steps of:
receiving, via a frontend, a query;
transmitting, to an engine, the query;
receiving, via the engine, a populated response;
displaying, via a client device, the populated response;
receiving, from the frontend, the query;
tokenizing, via the engine, the query;
generating an intent-match likelihood, via the engine, for each of a plurality of supported question intents;
classifying, via the engine, the query based on the intent-match likelihoods for each of the plurality of supported question intents;
evaluating, via the engine, each of the intent-match likelihoods to a confidence threshold;
extracting, via the engine and a Named Entity Recognition model, one or more entities from the query based on one or more prestored entities;
determining one or more entity values for each of the one or more entities;
querying at least one server database to incorporate intent to the one or more entities and the one or more entity values;
populating, via an action server, a response template with the one or more entity values based on one or more prestored entity values and one or more specifics to form a populated response,
wherein the one or more specifics are correlated to the one or more prestored entity values in the at least one server database via an entity value ID;
storing, via a tracker store, the query, the one or more entities, the one or more entity values, the one or more specifics, a user identification, a timestamp, and the populated response based on the intent-match likelihoods and the confidence threshold,
wherein the user identification corresponds to a user who transmitted the query, and
wherein the timestamp corresponds to the frontend's reception of the query; and generating an image on a network server, wherein the image is passed through to the populated response;
classifying a set of image-inducing entity values from the one or more prestored entity values;
classifying a first subset and a second subset from the set of image-inducing entity values;
generating, via the action server, a first subset image based on each of the first subset;
generating a first subset image link, via an object-based storage, for the first subset image;
transmitting the first subset image link, from the object-based storage to the frontend, if one of the first subset entity values exists within the query;
generating, via the frontend, a second subset image if one of the second subset entity values exists within the query; and
transmitting, to the frontend, the populated response.

(Item 63). A non-transitory computer readable medium having instructions stored thereon that, when executed by a processing device, cause the processing device to carry out an operation of chatbot interaction between a server and a client device, the operation comprising:
receiving, via a frontend, a query;
transmitting, to an engine, the query;
receiving, via the engine, a populated response;
displaying, via the client device, the populated response;
receiving, from the frontend, the query;
tokenizing, via the engine, the query;
generating an intent-match likelihood, via the engine, for each of a plurality of supported question intents;
classifying, via the engine, the query based on the intent-match likelihoods for each of the plurality of supported question intents;
evaluating, via the engine, each of the intent-match likelihoods to a confidence threshold;
extracting, via the engine and a Named Entity Recognition model, one or more entities from the query based on one or more prestored entities;
determining one or more entity values for each of the one or more entities;
querying at least one server database to incorporate intent to the one or more entities and the one or more entity values;
populating, via an action server, a response template with the one or more entity values and based on one or more prestored entity values one or more specifics to form a populated response,
wherein the one or more specifics are correlated to the one or more prestored entity values in the at least one server database via an entity value ID;
storing, via a tracker store, the query, the one or more entities, the one or more entity values, the one or more specifics, a user identification, a timestamp, and the populated response based on the intent-match likelihoods and the confidence threshold,
wherein the user identification corresponds to a user who transmitted the query, and
wherein the timestamp corresponds to the frontend's reception of the query; and
transmitting, to the frontend, the populated response;
populating the at least one server database with one or more addresses, each of the one or more addresses correlated to at least one of the one or more prestored entity values;
determining which of the one or more prestored entity values are within a boundary box to build a list of nearby entity values, wherein a center of the boundary box is based on one or more of the one or more entities;
ranking the list of nearby entity values based on distance to the at least one of the one or more entity values;
converting each of the one or more addresses to a geographical coordinate format; and
generating a nearby entity interface comprising at least the list of nearby entity values, wherein the nearby entity interface comprises a profile interface button for each of the list of nearby entity values, wherein actuation of the profile interface button generates a profile interface of the nearby entity value.

(Item 64). A system configured to administer operation of a chatbot, the system comprising:
a client device comprising at least one device processor, at least one display, at least one device memory comprising computer-executable device instructions which, when executed by the at least one device processor, cause the client device to:
transmit, to an engine, a query;
receive a populated response;
display, via the client device, the populated response; and
a server network in bidirectional communication with the client device, the server network comprising at least one server processor, at least one server database, at least one server memory comprising computer-executable server instructions which, when executed by the at least one server processor, cause the server network to:
receive the query;
generate an intent-match likelihood, via the engine, for each of a plurality of supported question intents;
classify, via the engine, the query based on the intent-match likelihoods for each of the plurality of supported question intents;
extract, via a Named Entity Recognition model, one or more entities from the query based on one or more prestored entities;
determine one or more entity values for each of the one or more entities;
query the at least one server database to incorporate intent to the one or more entities and the one or more entity values;
populate a response template with the one or more entity values and one or more specifics to form a populated response,
wherein the one or more specifics are correlated to the one or more entity values in the at least one server database;
store, via a tracker store, the query, the one or more entities, the one or more entity values, the one or more specifics, and the populated response based on the intent-match likelihoods; and transmit, to the client device, the populated response.

These and other aspects, features, and advantages of the present invention will become more readily apparent from the following drawings and the detailed description of the preferred embodiments.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 is an illustrative block diagram of a system based on a computer configured to execute one or more aspects of the chatbot functionality described herein.

FIG. 2 is an illustration of a computing machine configured to execute one or more aspects of the chatbot functionality described herein.

FIG. 3 is an illustration of an embodiment of the system architecture.

FIG. 4 is an illustration of an embodiment of the system architecture.

FIG. 5 is a workflow depicting an example of the system execution.

FIG. 6 is an illustration of an example chat interface.

FIG. 7 is an illustration of an example profile interface.

FIG. 8 is an illustration of an example nearby entity interface.

FIG. 9 is a workflow depicting an embodiment of nearby entity interface generation.

FIGS. 10A-10B are illustrations of example chat interfaces.

FIG. 11 is an example of a publication alert within a chat interface.

FIG. 12 is a workflow depicting an embodiment of publication alert generation.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

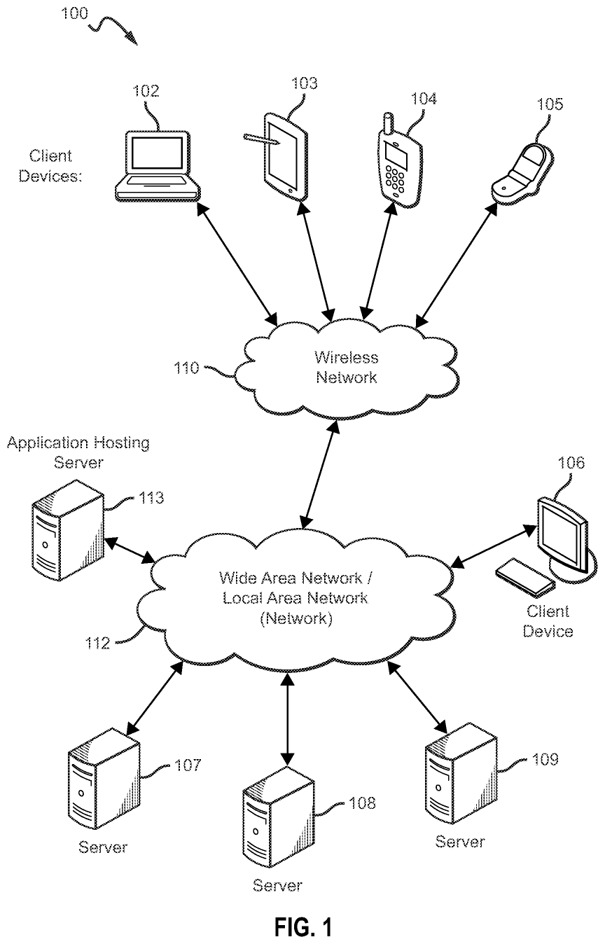

The present disclosure contemplates a chatbot module permitting sales representatives to inquire about customers and receive immediate and direct responses, in text and/or images. Accordingly, the chatbot module described herein may be configured to assist sales representatives navigate the complexity of customer data in a particular field (e.g., healthcare). By entering a question into the chatbot interface, and with a single click, a sales representative may access data previously distributed across a wide range of systems. The streamlined chatbot interface described herein may enable information discovery at a fraction of the speed it would take with traditional approaches. Accordingly, the system contemplated herein requires less network bandwidth than traditional systems. The system contemplated herein may require less network bandwidth because the chatbot module may be configured to only pull the data pertinent to the user's question, unlike a conventional dashboard that need to fully populate with all of the data regardless of user needs. As a non-limiting example, the systems and methods contemplated herein allow for more detailed review of the exact information accessed by sales representatives, which may inform strategy and allow for deeper analysis. FIG. 1 illustrates components of one embodiment of an environment in which the invention may be practiced. Not all of the components may be required to practice the invention, and variations in the arrangement and type of the components may be made without departing from the spirit or scope of the invention. As shown, the system 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. Various of the client devices 102-106 may include, for example, desktop computers, laptop computers, set top boxes, tablets, cell phones, smart phones, smart speakers, wearable devices (such as the Apple Watch) and the like. Servers 107-109 can include, for example, one or more application servers, content servers, search servers, and the like. FIG. 1 also illustrates application hosting server 113.

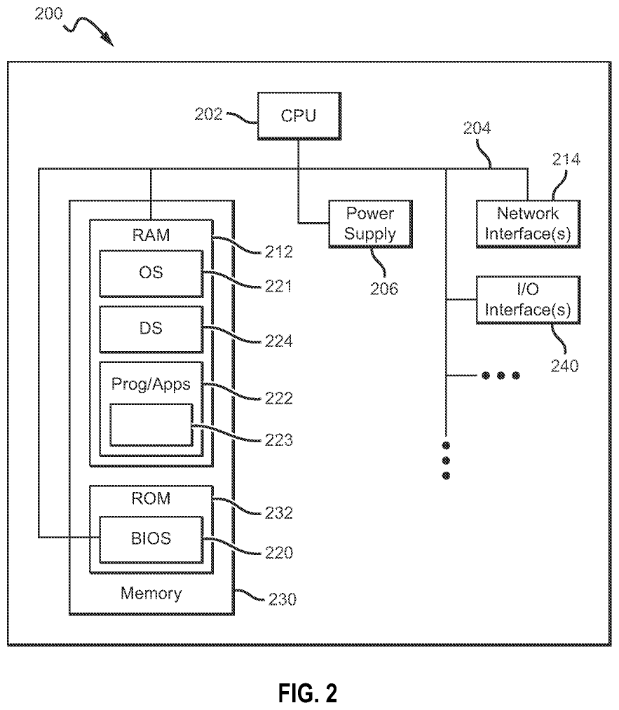

FIG. 2 illustrates a block diagram of an electronic device 200 that can implement one or more aspects of an apparatus, system and method for increasing mobile application user engagement (the “Engine”) according to one embodiment of the invention. Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software and other tools necessary to implement or facilitate methods and systems according to embodiments of the invention. The elements may exist on a single computer or be distributed among multiple computers, servers, devices or entities.

The power supply 206 contains one or more power components and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server may, for example, host a web site that can provide a user interface for administration of example aspects of the Engine.

Any computing device capable of sending, receiving, and processing data over a wired and/or a wireless network may act as a server, such as in facilitating aspects of implementations of the Engine. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system and method of the Engine. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the Engine. Content may include, for example, text, images, audio, video, and the like.

In example aspects of the apparatus, system and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system and method embodying the Engine, may range widely in terms of capabilities and features. For example, a cell phone, smart phone or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices 102-106, for example, as may be used in an example apparatus, system and method implementing the Engine, may run a variety of operating systems, including personal computer operating systems such as Windows, iOS or Linux, and mobile operating systems such as iOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, system and method implementing the Engine, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. Thus, in various embodiments, a non-transitory computer readable medium may comprise instructions stored thereon that, when executed by a processing device, cause the processing device to carry out an operation (e.g., extracting entities, determining intent, generating chatbot messages). In such an embodiment, the operation may be carried out on a singular device or between multiple devices (e.g., a server and a client device). A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system and method implementing the Engine, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G), 5^{th} (5G) generation, Long Term Evolution (LTE) radio access for cellular systems, WLAN, Wireless Router (WR) mesh, and the like. Access technologies such as 2G, 2.5G, 3G, 4G, 5G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the Engine, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present invention include apparatuses, systems, and methods implementing the Engine. Embodiments of the present invention may be implemented on one or more of client devices 102-106, which are communicatively coupled to servers including servers 107-109. Moreover, client devices 102-106 may be communicatively (wirelessly or wired) coupled to one another. In particular, software aspects of the Engine may be implemented in the program 223. The program 223 may be implemented on one or more client devices 102-106, one or more servers 107-109, and 113, or a combination of one or more client devices 102-106, and one or more servers 107-109 and 113.

As noted above, embodiments of the present disclosure may relate to apparatuses, methods, and systems for chatbot implementation and evaluation of data thereof. The embodiments may be referred to simply as the system.

The system may utilize the computerized and network elements as described above and as illustrated in FIGS. 1-2. Accordingly, the system may include hardware and software elements (as embodied in system 100 and electronic device 200) configured to execute the features of the algorithms and workflows described herein.

In an embodiment, the system may include a chatbot module. As a non-limiting example, the chatbot module may be utilized by sales representatives. In such an instance, the chatbot module may be configured to receive inquiries from the sales representative, process said inquiry, and output a corresponding answer. However, the chatbot module may be configured for use in any field and in conjunction with any task. In a further embodiment, the chatbot module may include or may be in informatic communication with an Artificial Intelligence (AI) component.

For instance, if the chatbot module is configured for use with pharmaceutical sales representatives, the chatbot module may be adapted to generate output pertaining to prescription patterns, patient populations, and drug market access. Accordingly, the chatbot module may both generate information as desired by the user and may utilize the user's queries to generate insights.

The chatbot module, and the system generally, may be accessible via a web-based application (e.g., accessible via a web browser), a mobile application (e.g., an “app” executable on a mobile operating system), or other platform. For example, the chatbot module may be displayed on a desktop computer, tablet, mobile device, wearable, smart device, or other computerized apparatus.

In an embodiment, the chatbot module may be configured to receive inquiries in text format. Similarly, the chatbot module may present output in text format, as well. The system, and/or specifically, the chatbot module, may include a user authentication layer (e.g., a login interface).

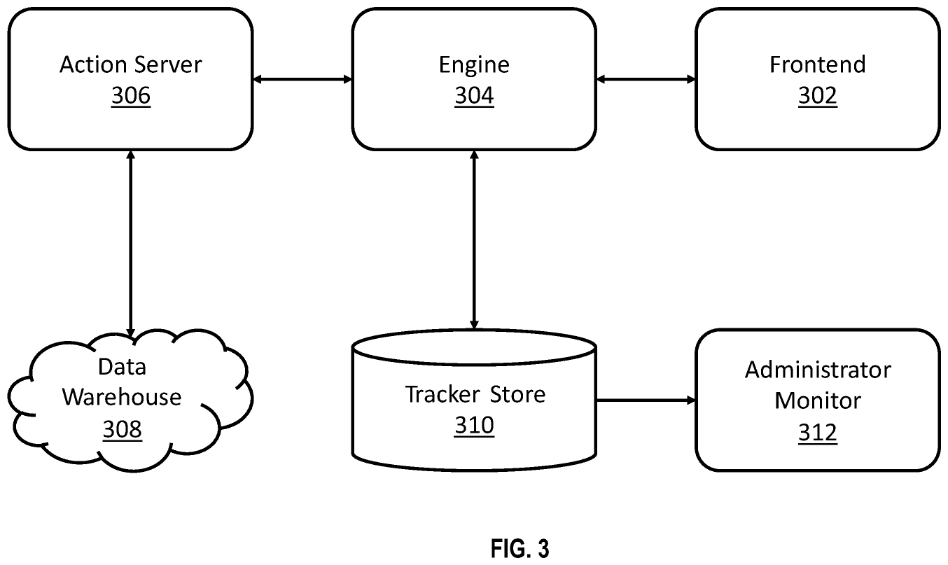

The system may include an architecture comprising a plurality of modules, servers, and/or computing devices. FIG. 3 illustrates an embodiment of the system. The frontend 302 may embody the elements of the system configured to execute on an electronic device 200, such as a smart phone, a mobile device, or computer. The frontend 302 may be in communication with an engine 304. The engine 304 may be configured to determine which category an inquiry belongs to and/or evaluate typos and/or syntax of the inquiry. In an embodiment, the engine 304 may be adapted to sort inquiries into one or more buckets, wherein each bucket may correlate to a particular entity and/or category. For the purposes of this disclosure, an inquiry may include one or more entities. As non-limiting examples, the entity may be a doctor's name and/or a particular timeframe. Thus, the engine 304 may be adapted to extract one or more entities from the inquiry. Further, the engine 304 may determine whether a particular entity is represented and/or is correlated to one or more entries in the database.

In an embodiment, the action server 306 may interpret the one or more extracted entities, generate a response by running queries against a data warehouse 308, and/or transmit the generated response to the engine 304. For the purposes of this disclosure, the data warehouse 308 may embody one or more or all of the databases, tables, and data stores described herein. Accordingly, references to the data warehouse 308 may be interpreted to include any of the other databases described herein and, vice versa, any of the other databases described herein may be interpreted to include the data warehouse 308. The data warehouse 308 may be in informatic communication with data from a range of systems and vendors, such as CRM platforms. Further, the engine 304 may be in communication with the tracker store 310, such that the tracker store 310 maintains records of the queries, responses, and characteristics thereof. Yet further, the engine 304 may transmit the response to the frontend 302, wherein the frontend 302 may provide a visualization of the response to the user. In an embodiment, the system further comprises an administrator monitor 312. The administrator monitor 312 may be a portal and/or device configured to permit administrative intervention and/or observation by one or more administrators.

The engine 304 may be initiated by a request from the frontend 302. Accordingly, the engine 304 may be adapted to detect signal(s) from the frontend 302. The initial signal reception from the frontend 302 to the engine 304 may be initiation of a chatbot session. In various embodiments, the engine 304 may exist within one or more client devices 102-106, one or more servers 107-109 and 113, or a combination of one or more client devices 102-106, and one or more servers 107-109 and 113. However, in alternate embodiments, the engine 304 may be an external module or service in informatic communication with the frontend 302, the action server 306, and/or other components of the system described herein. The engine 304 may be configured to generate one or more instances of the chatbot sessions to manage input inquiries from a plurality of users simultaneously.

The action server 306 may be embodied as a server, module, or software component configured to execute actions. The actions may be initiated by the engine 304 and may include, as non-limiting examples, image generation or response population. Accordingly, the functionality of the action server 306 may exist within a separate component and/or may be integrated into the engine 304 and/or another system component. In one embodiment, the action server 306 may be in informatic communication with the data warehouse 308, such that actions performed by the action server 306 may be informed by the data within the data warehouse 308. However, in alternate embodiments, the engine 304 may be in direct communication with the data warehouse 308, such that the engine 304 may be enabled to populate responses, generate images, etc. based on the data within the data warehouse 308.

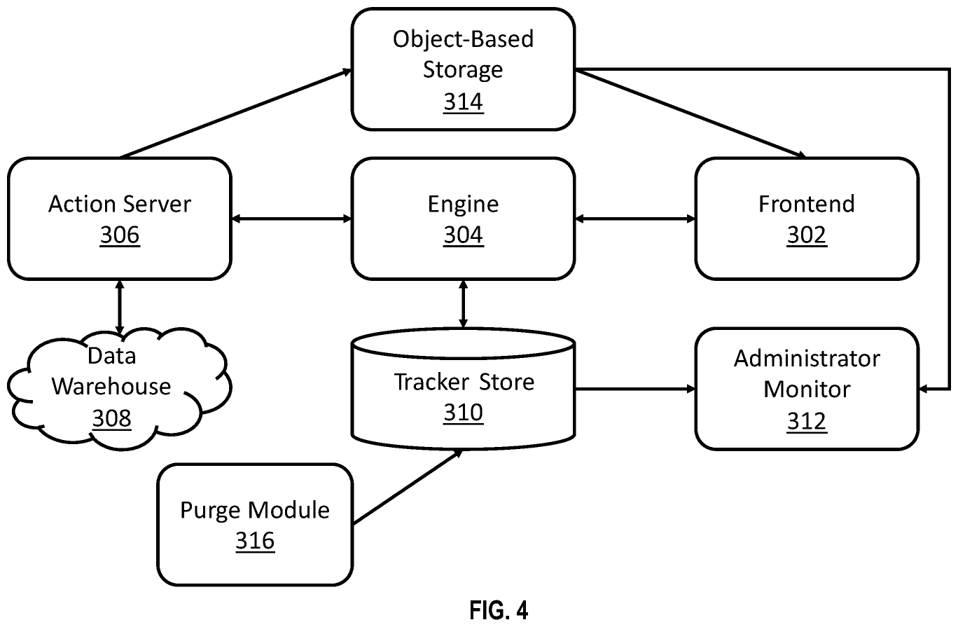

Referring to FIG. 4, the system may include an object-based storage 314 and/or a purge module 316.

The object-based storage 314 may be adapted to provide improved image generation for the chatbot module. In various instances, the chatbot module may deliver one or more images to a user in response to a user's inquiry. For example, the chatbot module may present one or more charts or figures based on an input inquiry. In an embodiment, when an input inquiry is received, if an image response is warranted, the image may be written to object-based storage 314, wherein a link to said image is generated and provided to the frontend 302. In various embodiments, the engine 304 and/or the action server 306 may be configured to determine whether an image output is warranted. As a non-limiting example, one or more intents and/or entities may be predetermined to warrant image generation. Accordingly, if one such intent and/or entity is determined by the engine 304 and/or the action server 306, an image may be generated and processed by the action server 306 and/or the object-based storage 314. The system may classify a set of image-inducing entity values from the one or more entity values, wherein the set of image-inducing entity values includes those entities and/or entity values that warrant a response in image form. Further, the set of image-inducing entity values may comprise a first subset and a second subset, wherein the first subset may refer to those entities that utilize image generation and link preparation via the object-based storage 314, and wherein the second subset may refer to those entities that utilize image generation within the frontend 302.

The object-based storage 314 may be configured to provide a link to the frontend 302, such that the frontend 302 may display the image. As a non-limiting example, the object-based storage 314 approach to image generation may be device and user agnostic, permitting the generated images to present in a consistent manner across a variety of user devices. Alternatively, if the image is passed to the client side for generation, the client device may generate an image inconsistent with the desired image characteristics. Accordingly, if an image is particularly detailed and/or requires a specific format to comprehend, image generation by way of the object-based storage 314 may be preferable. Moreover, by generating images through the object-based storage 314 pipeline, formatting control is maintained. As a non-limiting example, if an auditor or administrator wanted to review the manner in which an image was generated or was concerned with the use of a particular datapoint (e.g., compliance with various internal policies, laws, and/or industry regulations across various fields), the object-based storage 314 would be adapted to show the exact manner in which the visualization was portrayed. Thus, the auditor or administrator may review the identical image and its generation process and history. Conversely, with frontend 302 image generation, it may be difficult to recreate the exact visual displayed since it could be affected by frontend 302 software, user device type, browser, browser parameters, such as window size, and other considerations.

In another embodiment, the data necessary for generating an image may be passed to the frontend 302, wherein the frontend 302 may generate the image. As a non-limiting example, basic images (e.g., minimalistic charts or figures) may be generated on the frontend 302, wherein formatting is unlikely to be affected, or wherein slight formatting variations do not impact the user's interpretation of said images.

Accordingly, the engine 304 and/or the action server 306 may be configured to determine whether a particular image should be generated via the object-based storage 314 pipeline or should be passed to the frontend 302 for frontend 302 generation. In such an embodiment, a database may be maintained, wherein said database comprises a decision matrix for whether a particular category of image should be generated via the object-based storage 314 pipeline or should be passed to the frontend 302. Such a database may be prepopulated by an administrator. Accordingly, entities stored within the data warehouse 308 may be tagged for image generation via the object-based storage 314 pipeline or the frontend 302 image generation pipeline, such that retrieval of said entity induces the corresponding method of image generation.

In an embodiment, a purge module 316 may be in informatic communication with the tracker store 310. Accordingly, the purge module 316 may be configured to provide automation to a data retention policy. The purge module 316 may be adapted to purge or otherwise process data within the tracker store 310 upon a trigger. A trigger may be defined by a particular durational event (e.g., every 24 hours) or may be implemented ad hoc via a manual actuation. The purge module 316 may be configured to erase content while maintaining the metadata or portions thereof (e.g., identity of inquirer, the template used for said response, and any information that was extracted from the message). Thus, the message itself may be deleted.

The purge module 316 may be configured with a retention policy, wherein a first set of information is saved or purged at a first interval (e.g., every 3 months), and wherein at a second interval (e.g., every day) the purge module 316 is adapted to review whether the tracker store 310 contains any text that has not yet been purged. For example, the purge module 316 may review the text timestamp and compare said text timestamp to the current time to determine whether the underlying data should be marked for purging or whether said datapoint should be stricken out as expired. The purge module 316 may be further configured to purge information at a third interval (e.g., every 7 years), wherein such a purge includes deletion of all message data, including the metadata listed above. For example, the third interval may align with a data retention policy that requires that chat messages be retained for a first interval (e.g., 120 days) and application logs be retained for a third interval (e.g., 7 years).

Thus, the purge module 316 may be configured to identify and/or purge a first set of information at a first interval, a second set of information at a second interval, and a third set of information at a third interval. However, the purge module 316 may be configured to identify and/or purge any suitable quantity of information sets at any suitable quantity of intervals, wherein each interval may be any suitable frequency of time. In various embodiments, the first set of information, the second set of information, and/or the third set of information may or may not contain the same segments of data. Accordingly, by alteration of the first set of information, the second set of information, the third set of information, the first interval, the second interval, and/or the third interval, the purge module 316 alone may be adapted to purge data in accordance with numerous data retention policies.

In various embodiments, the purge module 316 and the overarching compliance aspects of the systems and methods described herein are enabled by the system's ability to provide specific identifiable datapoints (e.g., HCP name and information, drug information, and sales numbers) within a response message that appears as “natural” text. The templated response may provide the appearance of “natural” text, while providing a means of identifying, extracting, and storing sensitive datapoints within said response.

In an embodiment, the natural language processing (NLP) model may be or may include a named entity recognition (NER) model. As a non-limiting example, the NER model may extract and/or identify a specific form of information from text. In an embodiment, the NER model may perform an identification step. During the identification step, the NER model may identify one or more entities from a textual input, creating an identified entity. The NER model may further perform an extraction step. In such an extraction step, the NER model may extract the identified entity from the textual input, creating an extracted entity. Said extracted entity may be one or more words referring to a subject. As a non-limiting example, the subject may include categories of information such as, location, time, colors, etc. Further, the NER model may perform a categorization step, wherein said step may categorize the extracted entity into at least one subject.

In a further embodiment, the NER model may be trained on a training set. In such an embodiment, at least one document, containing textual input, is placed into the training set. Further, the textual input comprising the at least one document may be preprocessed. Preprocessing the at least one document may be accomplished through labelling the textual input of the at least one document. Said labelling may involve categorizing individual words, comprising the textual input, into the subject creating categorized text. The categorized text may comprise the training set, wherein said training set may be utilized for training a recurrent neural network.

One aspect of the solution described herein is extraction of provider names from chat style text. Conventional and/or prepackaged name extraction models may be trained on edited materials (e.g., encyclopedic literature or academic texts), which biases the model towards only identifying names in full sentences with proper punctuation. Accordingly, the NER model of the instant disclosure may be trained on collected real chat messages, manifesting an NER model that is sensitive to the nuances of names (e.g., a person's name, such as a HCP's name) in chat style text. In various embodiments, the NER model may be trained on chat style text with the nuances of any relevant field (e.g., chat style text including colloquial metallurgic terms for a chatbot configured for precious metal sales, or chat style text including colloquial agricultural terms for a chatbot configured for farm equipment sales, etc.).

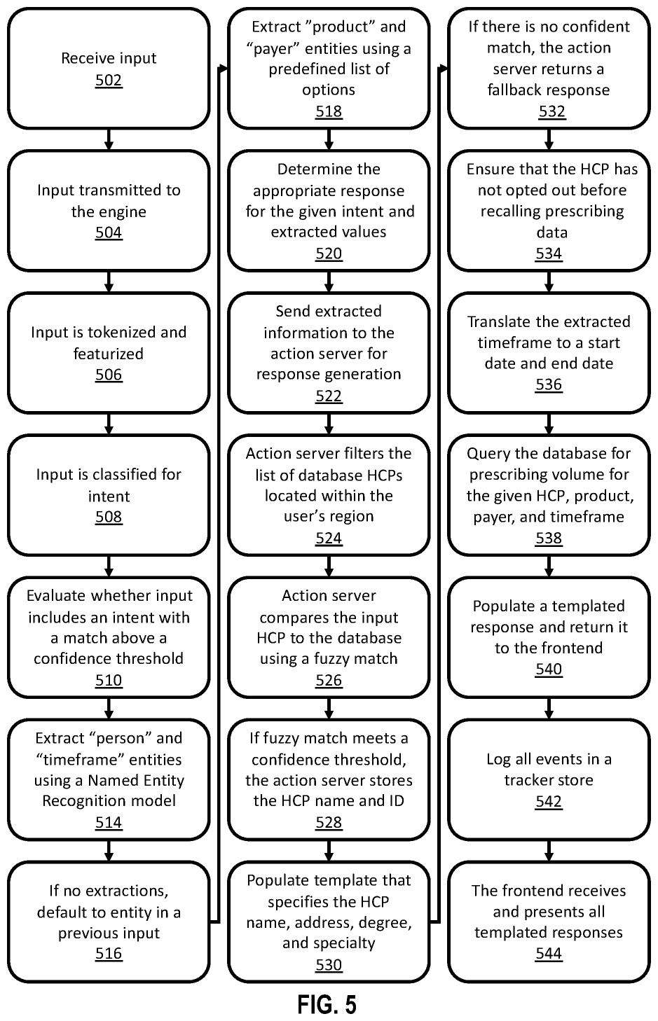

FIG. 5 illustrates an embodiment of a chatbot workflow in the field of pharmaceutical sales, however, aspects of the workflow of FIG. 5 may be altered, as described below, for use with any suitable field. The user may ask the chatbot module, for example, via the client device 200, “How many ‘Drug X’ prescriptions did Dr. John Smith write in the past 4 weeks?” Accordingly, at step 502, the chatbot module may receive the input, for example, from the frontend 302 to the engine 304. However, the chatbot module may be configured to receive a query of any related content (e.g., software sales, agricultural sales, insurance inquiries, etc.). The input may be received as free text. For the purposes of this disclosure, “free text” may refer to unstructured texts that contain narrative sentences or other natural language components (i.e., not immediately comprehensible by machines). Next, the input may be transmitted to the engine 304 (e.g.,, a RASA chatbot engine). As described above, any suitable engine 304 may be utilized. In an embodiment, at step 506, the system may tokenize and featurize (i.e., a default configuration provided by the engine architecture) the message. As a non-limiting example, tokenization may separate the input into one or more words (e.g., via white space tokenization). As a non-limiting example, featurization may include use of pre-trained word embeddings. Such non-limiting examples may include generating a contextual vector representation for the entire input (e.g., a sentence of free text), or may include use of NLP models (e.g., BERT) to extract similar contextual vector representations for the entire input (e.g., a sentence of free text). However, custom trained NLP models may also be used, for example, those trained on domain-specific training data (e.g., chat transcripts). In an alternate embodiment, the tokenization and featurization may be carried out by a single tool, such as a whitespace tokenizer.

Further, at step 508, the system may classify the message with a given intent. For each possible question intent supported by the bot, the engine 304 and/or the action server 306 may generate a score of the likelihood that the question matches that intent. For example, as depicted in FIG. 5, questions/intent matches to “Ask HCP Volume” with high probability. In an embodiment, at step 510, the system may check to determine if one or more of the intents are a sufficient match (i.e., greater than 60% match). If not, the system may return a fallback response. In FIG. 5, the system has determined sufficient confidence in the intent.

As a non-limiting example, at step 514, the system may extract “person” and “timeframe” entities (or any suitable entity) from the message using the NER model. However, in alternate embodiments, the system may utilize any suitable model in extracting entities. While the example of FIG. 5 may extract “person” and “timeframe” entities, more generally the system may be configured to first extract a first set of entities. In the case of the example of FIG. 5, the model may extract the person “Dr. John Smith” and the timeframe “the past 4 weeks”. Person extraction may first include correcting the capitalization of the message using a language modeling tool (i.e., Truecase or similar tools), and then passing the message through a model (i.e., SpaCyNLP's NER model). However, in a further embodiment, the system may utilize a custom trained model (i.e., a custom trained SpaCy model). Such a custom model may represent an improvement over “off-the-shelf” models, as such conventional models are trained on content (e.g., published articles or encyclopedia entries) that has been edited for capitalization and punctuation, but chat data often includes typos, vernacular, and other differentiating textual characteristics. Furthermore, such a model may be configured to ascertain words that are not typically names (i.e., “hall”), but in the context of this chatbot module are typically names. In the instance of FIG. 5, a name may be successfully extracted, but if none were extracted, at step 516, the chatbot module may default to a previously mentioned entity, for example the person (i.e., the HCP) inquired about in a previous message. If the chatbot module is unable to extract an entity from the first message, the chatbot module may output a response requesting that the user retype and/or resubmit their initial message.

In an embodiment, at step 518, the system and/or, specifically the chatbot module, may extract entities from the message (i.e., “product” and “payer”) using a predefined list of options, including one or more spelling errors. In the example of FIG. 5, the system may not find any payers and may extract the product “Drug X”. While the example of FIG. 5 may extract “product” and “payer” entities, more generally the system may be configured to next extract a second set of entities. For the purposes of FIG. 5, the system may be configured to extract a first set of entities and a second set of entities in sequential order, however, in various embodiments, the system may extract any number or combination of sets of entities in any suitable order or in tandem.

At step 520, the bot may utilize a rule to determine the appropriate response for the given intent and extracted values. In an embodiment, the action server 306 may utilize the retrieved intent and entity to construct a response. For example, a given templated response may include one or more variables fillable based on the retrieved intent and/or entity. The action server 306 and/or the engine 304 may be configured to recall one or more template responses for each retrieved intent. Thus, the action server 306 may populate the correlated template response based on the retrieved intent, wherein the variable components of the correlated template response are filled with specifics correlated to the retrieved entity and/or entity value. Thus, at step 522, the bot may transmit the gathered information to the action server 306 for response generation. For the purposes of FIG. 5, a healthcare professional (HCP) may be contemplated as a significant entity. However, the steps described herein may be applicable to any entity, for example, a “person” entity or target of sales within a different field (e.g., plant managers for industrial sales, farmers for agricultural sales, and educators for education services).

At step 524, the action server 306 may be configured to filter the list of database HCPs located within the user's region or territory. Accordingly, the action server 306 and/or the engine 304 may be adapted to compare the user's location to that of the HCPs within the database. Such a comparison may be based on GPS information retrieved from the client device and/or from location data previously entered by the user. Further, at step 526, the action server 306 may compare the input HCP (e.g., an HCP derived from the input inquiry) to the database utilizing a fuzzy match (e.g., thefuzz WRatio), and may select the best match. For example, as shown at step 528, if the match has greater than 80% confidence, the action server 306 may store the HCP name and ID, and, at step 530, may populate a message template to be sent to the user which specifies the HCP name, address, degree, and/or specialty. However, the action server 306 may be configured to match upon any suitable confidence level, may store any relevant entities or characteristics, and may populate a message with any quantity of values correlated to said relevant entities or characteristics. In an embodiment, at step 532, if there is no confident match, the action server 306 may return a fallback response. In an embodiment, at step 534, the action server 306 may be adapted to ensure that the HCP has not completed a Physician Data Restriction Program (PDRP) opt-out before pulling prescribing data. More generally, the system may be configured to determine whether an entity's correlated information is presentable to the user based on any imposed restriction, which, for example, may be tagged on the entity or correlated information in the data warehouse 308. However, the action server 306 may be configured to determine whether the HCP (or other entity) has met any testable condition. Thus, in instances of other entities or other fields, any relevant conditions may be evaluated at this step.

Further, at step 536, the action server 306 may translate the extracted timeframe to a start date and end date using a library for processing temporal expressions (e.g., SUTime). At step, 538, the action server 306 may query the database to pull prescribing volumes for the given HCP, product, payer, and timeframe. However, in further examples, the action server 306 may query the database for any suitable information. Thus, in instances of other entities or other fields, any related specifics may be retrieved based on a given entity. Accordingly, the system may be adapted to recall an accompanying set of specifics for a given entity. In such an embodiment, a given entity may be linked to an accompanying set of specifics, such that retrieval and/or recall of an entity initiates retrieval of the accompanying set of specifics. As a non-limiting example, if a “person” entity is retrieved, specifics including, address, and phone number may be recalled and/or may be utilized in the templated response. In an embodiment, at step 540, the action server 306 may populate a templated response and may return said populated templated response to the chatbot module. In yet a further embodiment, at step 542, the system may log all events and information via a tracker store 310. Ultimately, at step 546, the frontend 302 may receive and present all populated templated responses.

This exemplary workflow depicted above describes the procedures executed by the system upon receiving a particular inquiry to the chatbot module. The provided workflow depicts one particular path; however, subsequent paths may deviate based upon the input inquiry and subsequent analysis thereof.

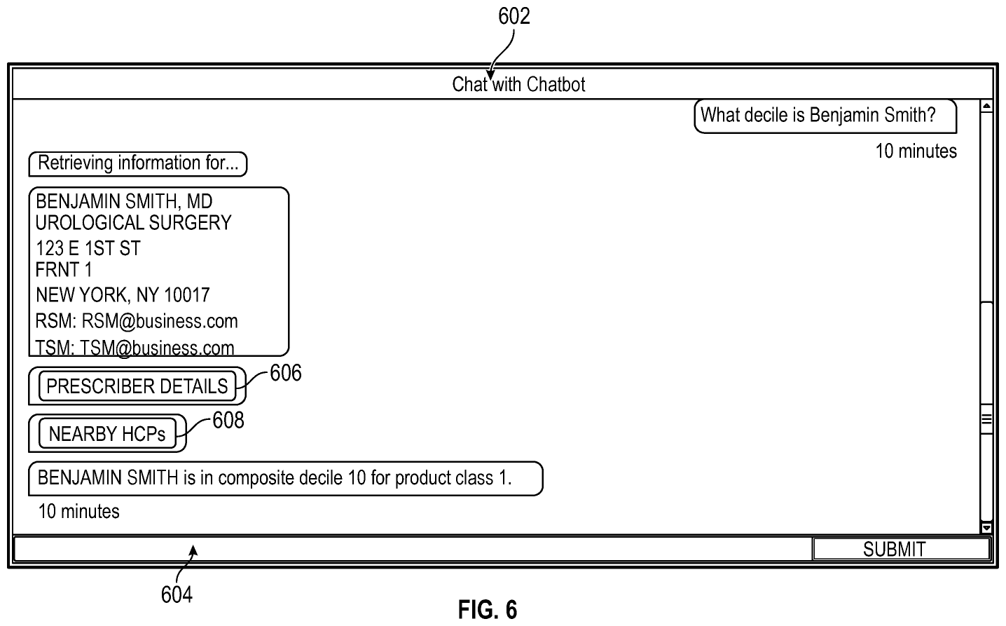

The system may include a chat interface as shown in FIG. 6. The chat interface 602 may be displayed on the frontend 302 such that the chat interface 602 may be interactively presented on the user device 200. The chat interface 602 may include a title disposed atop the chat interface 602. The title may correlate the chat interface 602 with the recipient of said chat. The chat interface 602 may further comprise a text entry tool 604, allowing a user to input text via the user device 200. In an embodiment, the user device 200 may include a microphone or other means of capturing audio, enabling speech-to-text input. As text populates the body of the chat interface 602, a scroll bar may generate, permitting a user to scroll through past chat messages. As shown in FIG. 6, the chatbot module may be configured to evaluate typos, misspellings, and/or improper grammar and punctuation. In one embodiment, the chat interface 602 may include one or more hyperlinks embedded within the chatbot's messages.

The chat interface 602 may include a first actuator 606 and/or a second actuator 608. The first actuator 606 and/or the second actuator 608 may be configured to generate and/or display one or more interfaces associated with the subject of a chatbot message. As non-limiting examples, and as described in more detail below, the first actuator 606 may be configured to generate and/or display a profile interface 702 and the second actuator 608 may be configured to generate and/or display a nearby entities interface 802.

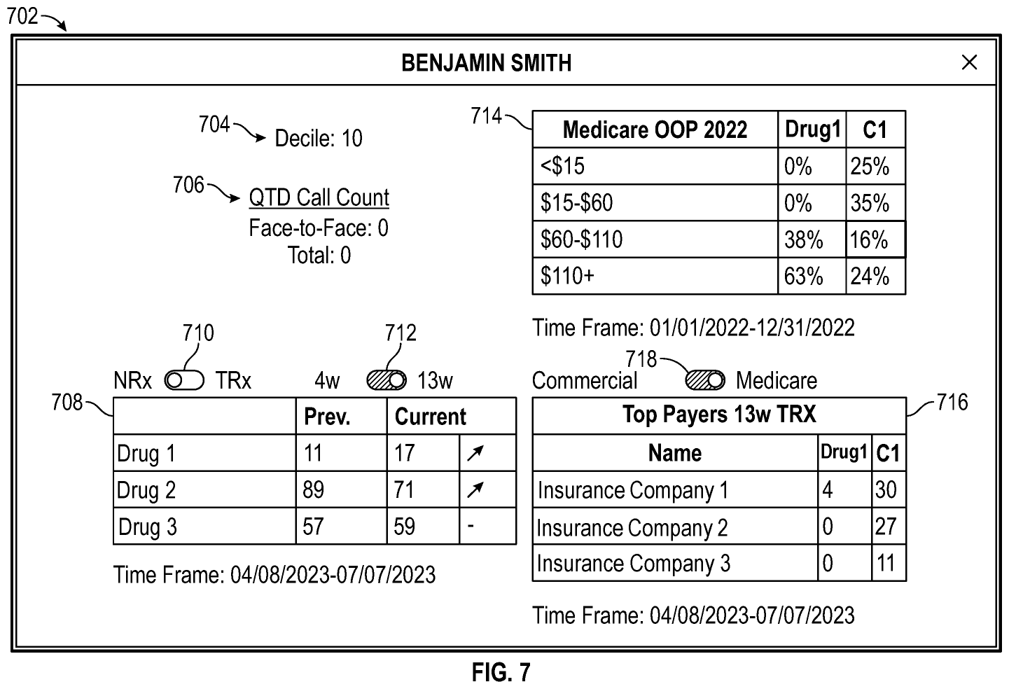

The system may further comprise a profile interface 702, as shown in FIG. 7. The profile interface 702 may be presented after actuation of one or more hyperlinks and/or actuators (e.g., the first actuator 606) within the chat interface 602. The profile interface 702 may include information pertaining to the subject of the instant response (e.g., the HCP). The profile interface 702 may include a decile indicator 704 and/or a history indicator 706. The decile indicator 704 may be informed by sales history or other pertinent data. The decile indicator 704 may be informed by a metric provided to the field in various reporting channels. Such a “decile” may be adapted to estimate the priority level of calling on a particular HCP (or other entity) based on a variety of criteria such as their prescribing history (or other characteristics). Accordingly, in various fields the decile metric may be directed to any target (e.g., a purchaser, a product, etc.) and may be informed by any correlated information (e.g., purchase history, price fluctuations, financial projections, geographic data, etc.).

The history indicator 706 may be reflective of encounters with the instant HCP, for example, the number of face-to-face meetings, the number of telephonic meetings, and/or the number of total meetings. Information for the history indicator 706 may be informed by the tracker store 310 and/or an external or third-party software tool (e.g., a customer relationship management tool).

The profile interface 702 may comprise a product data table 708 comprising a quantity selection tool 710 and a timeframe selection tool 712, wherein the quantity selection tool 710 may be configured to alter the product data table 708 from a total product metric to a new product metric, and wherein the timeframe selection tool 712 may be configured to alter the product data table 708 from a first timeframe to a second timeframe. The profile interface 702 may comprise a payer table 716 comprising a payer selection tool 718, wherein the payer selection tool 718 may be configured to alter the payer table 716 from a first payer category to a second payer category.

The product data table 708 may manifest as a prescription data table, wherein the prescription data table comprises a prescription quantity selection tool (e.g., embodied by quantity selection tool 710) and/or a prescription timeframe selection tool (e.g., embodied by timeframe selection tool 712). The prescription quantity selection tool may include two or more selectable prescription quantity metrics that, upon actuation, may influence the populated data in the prescription data table. As a non-limiting example, the prescription quantity selection tool may include options for total prescriptions (TRx) and new prescriptions (NRx). The prescription timeframe selection tool may include two or more selectable timeframes that, upon actuation, may influence the populated data in the prescription data table. As a non-limiting example, the prescription timeframe selection tool may include options for 4 weeks and 13 weeks. Accordingly, actuation of a particular timeframe may cause a trend directional to reorient based on the change in prescriptions over the selected timeframe.

The profile interface 702 may include a cost table 714, wherein the cost table 714 may include the out-of-pocket cost of one or more products (e.g., drugs). For the purposes of this disclosure, “C1” may refer to “product class 1,” wherein, for example, the product class may refer to a class of drugs. Accordingly, the product class may include a summation of one or more products, for example, one or more related drugs. In a non-limiting example, the product class may include a plurality of drugs sharing a similar characteristic. This may enable a user to compare a particular drug with the overall class of said drug. The profile interface 702 may comprise a payers table 716, wherein the payers table 716 comprises a payer selection tool 718. The payer selection tool 718 may include two or more selectable payer categories. As non-limiting examples, the payer selection tool 718 may include an option for commercial insurance and Medicare. Actuation of the payer selection tool 718 may cause the payer table 716 to display the total number of prescriptions covered by the selected payer category. In an embodiment, the payer table 716 may display prescription data over a fixed timeframe. However, in a further embodiment, the payer table 716 may include a selection tool allowing the payer table 716 to display information over a selected timeframe.

The profile interface 702 may provide a wealth of information that would otherwise require multiples clicks, numerous windows, or a multitude of software programs to access. Further, various components of the profile interface 702 may include date indicators configured to display the date of the underlying data (e.g., the date when the underlying data was accessed and/or published).

The system may comprise a number of exemplary questions correlated to one or more characteristics, categories, and/or entities. Such questions may be maintained and/or accessed via the engine 304. A non-limiting list of categories may include call history, HCP information, HCP volume, HCP decile, HCP market share, HCP commercial vs Medicare, HCP copays, compliance questions, and logistical questions.

For the purposes of this disclosure, “intent” may refer to the purpose of the user's inquiry in the conversational exchange. Further, “entity” may refer to a data point or value, or category of data points or values, that may be extracted from the user's inquiry. Each entity may be correlated to a database comprising entity values, wherein a particular entity value (i.e., “Dr. Smith”) includes an entity value ID. The entity value ID may be utilized to determine additional details correlated to the entity value. The entity value ID may be matched to the query and to various specifics (e.g., number of scripts prescribed, office address, etc.) via one or more databases. Such databases may be hosted via the server network. As a non-limiting example, an entity may be the category of “doctor”, the entity value may be “Dr. Smith”, the entity value ID may be DOC12345, and a specific may be “28 scripts,” referring to the number of Drug X scripts written by Dr. Smith. However, in alternate embodiments, the chatbot module may utilize various categorization schemes, tagging methods, data recall procedures, database querying, and/or value identification. Thus, the spirit of the present disclosure should not be viewed as limited to a particular “intent” and “entity” mapping method.

In an embodiment, the system may utilize the data stored within the tracker store 310 to generate insights. Accordingly, the content and intent of the amassed queries may be evaluated to determine such insights. Traditionally, such data would be difficult to log. However, via the chatbot module and the tracker store 310, each query may be logged, in addition to the answer, content, and intent. Further, machine labels may be applied to tag each particular doctor, timeframe, product, or other entity. In this manner, the system may calculate various tailored statistics, generate graphical visualizations, and distill frequently raised content and content categories. As a non-limiting example, sales leaders may strategize that their team should focus on a particular HCP specialty. In such a non-limiting example, using data from the tracker store 308, a dashboard could be generated which shows the specialty breakdown that each user is asking about, aggregated to their region or territory. Thus, in such a non-limiting example, if the leader sees that one particular region is lagging behind in asking about that specialty, it could indicate that that region needs further reinforcement training of the new strategy.

The chatbot module may allow a user to view multiple types of data without being forced to change windows or assess different interfaces. Thus, the chatbot module may be in informatic communication with various databases, allowing a widespread dataset to be presented in a singular chat interface. For example, the system may include a hub wherein data from various sources, such as call data, prescribing data, CRM data, logistical information (in some instances, admin-populated data) may merge.

The system may include an extraction model configured to evaluate a query for embedded entities. Such embedded entities may include doctor names, drug names, or timeframes. Traditional extraction models may be trained on scholarly sources and/or published articles. Thus, such traditional extraction models may prove insufficient in extracting entities from ‘colloquial’ text messages. Accordingly, in a further embodiment, the extraction model may be configured to recognize alternate spellings and typos. As a non-limiting example, once a name is extracted, the system may filter the doctor name database to the scope of the user who is submitting the query. For example, there may be a great number of doctor “Smith's” throughout the country, but only one within this user's geographical region. The geographical region may be pre-correlated with the user and/or may be evaluated based on GPS functionality of the user device 200. After filtering the doctor name database, the System may perform a fuzzy match or utilize the nearby entity functionality (described above), evaluating the user's input in view of the filtered database results to determine the best match.

The system may include a response generation tool. Accordingly, the system may include a response template that may be populated by retrieved data. Such a populated response may be transmitted to the frontend 302 and the user device 200.

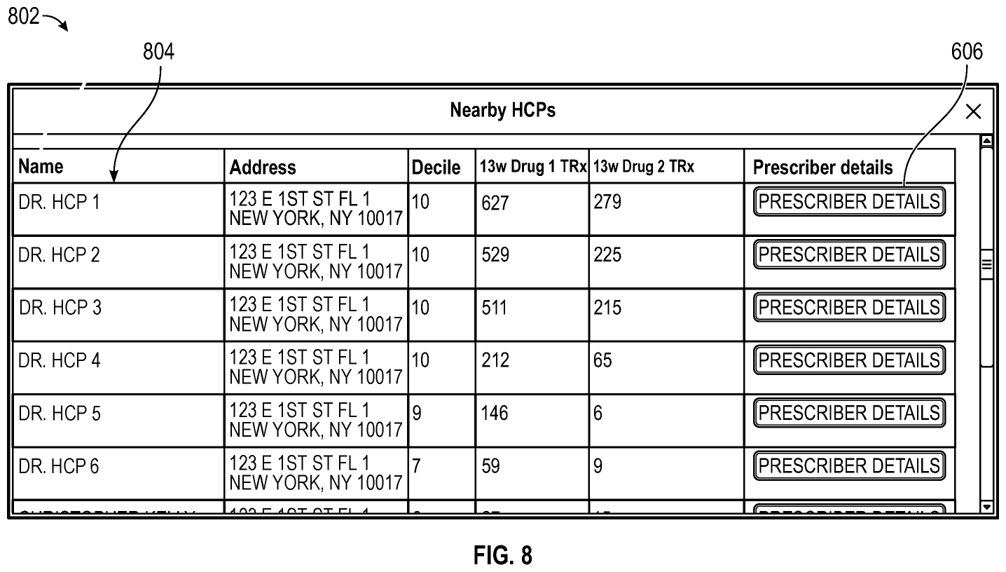

Referring to FIG. 8, a nearby entity interface 802 may display one or more entities within a predetermined proximity to an instant entity (e.g., the entity or entity value extracted from the input inquiry).

The nearby entity interface 802 may include one or more entries 804, wherein each entry displays data correlated to said entity. As a non-limiting example, each entry 804 may include the name of the HCP, address, decile, total prescriptions of one or more drugs, and a first actuator 606.

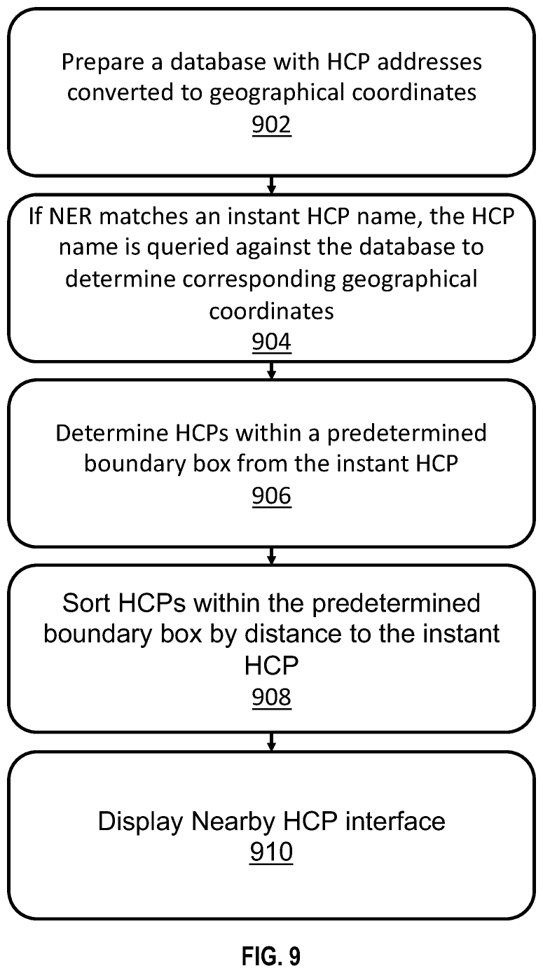

FIG. 9 illustrates an embodiment of a workflow adapted to generate a nearby entity interface 802. At step 902, in an embodiment, a database may be prepared containing addresses associated with each entity. The addresses may be converted from standard street address format to geographical coordinates, for example, latitude and longitude. The geographical coordinates and/or the street addresses may be maintained in the database. At step 904, in an embodiment, if the NER model identifies a particular entity, said entity may be queried against the database to determine the entity's corresponding geographical coordinates. At step 906, in an embodiment, additional entities (e.g., sharing the same category or entity type, such as “person”) within a predetermined boundary box from the instant entity may be identified. The predetermined boundary box may be a maximum distance from the instant entity, wherein entities within said predetermined boundary box may be considered “nearby” for the purposes of the nearby entity interface 802. The predetermined boundary box may include a radius of 1/1000 of a degree. However, the predetermined boundary box may include any suitable dimensions. At step 908, in an embodiment, the entities within the predetermined boundary box may be sorted by distance to the instant entity. In various embodiments, any suitable metric for distance may be utilized. In an embodiment, Euclidean distance may be utilized to rank the distance between the instant entity and one or more of the entities within the predetermined boundary box. At step 910, in an embodiment, the identified nearby entities and correlated information thereof may be populated and displayed in the nearby entity interface 802.

Further, the system may be further comprised of or in communication with a GPS system. The GPS system may be comprised of at least one of one or more satellites, one or more ground stations, and one or more receivers. In an embodiment, the one or more ground stations may emit a first locating signal to the one or more satellites. The first locating signal may be capable of identifying a location of the one or more satellites. In a further embodiment, the one or more satellites, after receiving the first locating signal, may emit a second locating signal. In such an embodiment, the one or more receivers may be configured to continuously search for the second locating signal. Additionally, the second locating signal may transmit location information, wherein said information corresponds to a geographic location of the one or more receivers. In yet a further embodiment, the one or more receivers may be integrated into the client device. As a nonlimiting example, the one or more receivers, integrated within the client device, may display, via a display, the geographic location of the client device.

In an embodiment, the GPS system may interface with the database. In the aforementioned embodiment, the database may include the geographic location of the nearby entity interface 802. As a nonlimiting example, the GPS interface may query the geographic location of the client device against the geographic location of the entities within the database. In such a nonlimiting example, the client device may compare the distance from the geographic location of the client device against the geographic location of the entities (e.g., those entities within a boundary box of the instant entity), and relay said distance to the user.

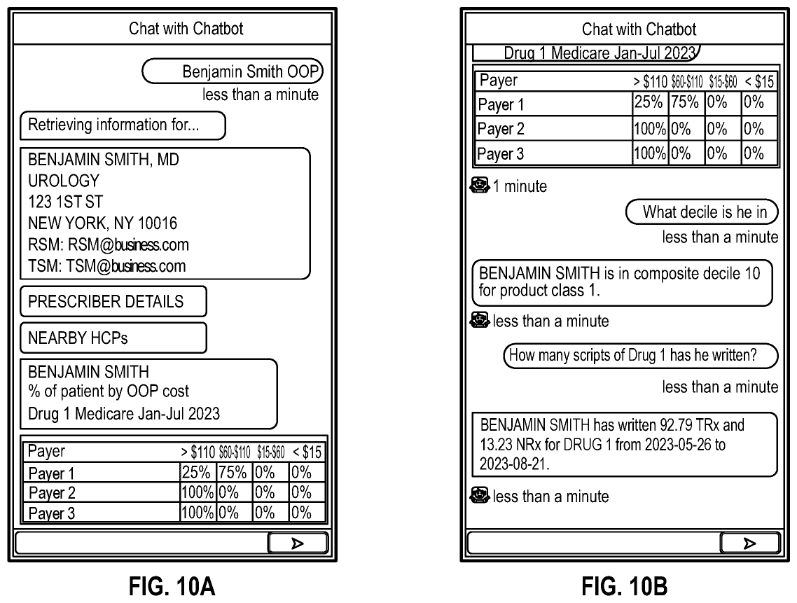

FIGS. 10A-10B depict examples of chat interfaces, for example, as displayed in mobile embodiments of the user device 200.

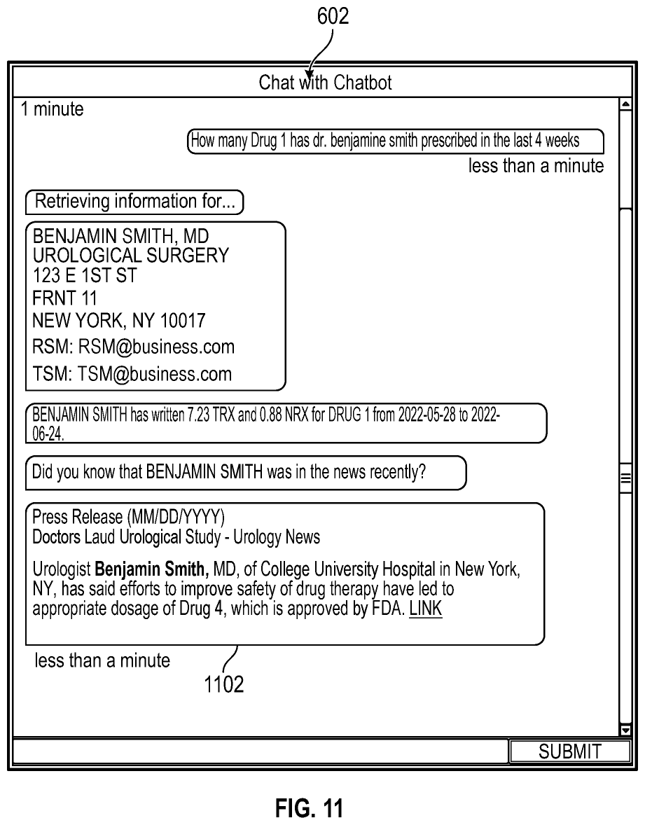

FIG. 11 illustrates an embodiment of a publication alert 1102. The publication alert 1102 may be a textual or visual element presented within the chat interface 602, wherein the content of the publication is correlated to the instant entity or other element of the chat input or response. As a non-limiting example, if a user inputs a message about a particular HCP, said HCP may be queried against a database containing publications correlated to one or more HCPs, and a publication related to said HCP may be presented to the user in the chat interface 602. The publication alert 1102 may contain content correlated to any suitable document associated with a particular input element. As non-limiting example, the “publication” for the purposes of publication alert 1102 may include journal entries, scientific publications, news articles, social media posts, and other retrievable documents. Furthermore, although FIG. 11 depicts an example of a publication correlated to an HCP, the publication may be associated with any suitable entity value (e.g., drug, product, address, etc.).

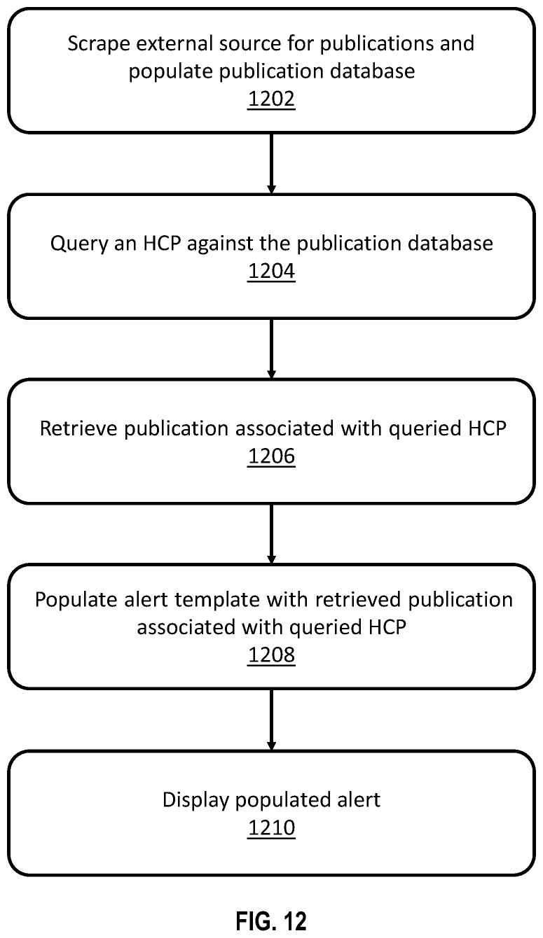

The publication alert 1102 may be generated via the steps shown in FIG. 12. In an embodiment, at step 1202, an external source may be scraped for publications and a database may be populated with said publications. The external source may be a database of publications, a web platform, an internet source, or any suitable source of publications. The aforementioned database may be populated with the publication(s) (or a portion thereof) and at least one identifier tagged on said publications, wherein the identifier correlates the publication to at least one entity (e.g., HCP, drug, etc.). Machine Learning (ML) models and/or Natural Language Processing (NLP) techniques may be utilized to identify publications within the external source that are correlated to one or more of the relevant entities.

At step 1204, if the NER model identifies an HCP (or other entity value), the HCP may be queried against the aforementioned databases. In an embodiment, at step 1206, the publication associated with the queried HCP may be retrieved. In another embodiment, a reduced version of the publication or key data of said publication may be retrieved. The reduced versions of the publication may be generated via generative AI or via other machine learnings techniques. For example, the full text of the publication may be utilized by said generative AI or other machine learning technique to create a short description, summary, or abstract of the publication. In an embodiment, at step 1208, an alert template may be populated with the content contained within the retrieved publication associated with the queried HCP. The alert template may include the title of the publication, the date of publication, an abstract of the publication, and a link to said publication. At step 1210, the populated publication alert 1102 may be presented via the chat interface 602.

In a further embodiment, the publication alert workflow may be utilized to alert the chatbot user to events other than news articles or academic publications. For example, the publication alert workflow may be configured to deliver alerts comprising prescription data, sales data, or other internal data. As a non-limiting example, a publication alert 1102 may include information regarding the HCP's most recent prescription or the quantity of prescriptions for a particular drug. In such a non-limiting example, the engine 304 and/or action server 306 may be configured to interpret two entities from a chat input and identify a publication within the publication database that correlated to the two entities. For example, the engine 304 and/or the action server 306 may extract “Dr. Smith” and “Drug A,” and a publication may be presented to the user, wherein the publication states that “Dr. Smith wrote their first prescription for Drug. A on August 31.”

In a further embodiment, the Chatbot module may interface with the client device 200. In another embodiment, the Chatbot module may generate at least one push-notification on the client device 200, wherein said notification may be displayed on a display of the client device 200. As a nonlimiting example, the Chatbot module may generate the at least one push notification, on the client device 200, in response to processing the inquiry. As a further nonlimiting example, the Chatbot module may generate the at least one push notification, on the client device 200, in response to outputting the corresponding answer to the user inquiry. Moreover, notifications may be passed to the client device 200 informing the user to utilize the chatbot module. As a non-limiting example, notifications may be generated if the chatbot module has not received input from the user within a predetermined period of time. Accordingly, the integration and communication between the chatbot module and the client device 200 may improve user engagement with the Chatbot module. As a non-limiting example, the Chatbot module may be adapted to send reminder messages such as “How can I help you today” or “Which HCPs will you be visiting today.” Further, the Chatbot module may be adapted to send push notifications for timely alerts such as “Dr. Smith just wrote their first Drug X prescription” or “Dr. Smith just clicked a link in a promotional email” via the client device 200.

As described herein, the system may be tailored for use within pharmaceutical sales. However, in alternate embodiments, the procedures and processes described herein may be utilized in any suitable field or discipline. For example, the engine 304 may be adapted for evaluation of content relating to any field.

In some aspects, the techniques described herein relate to a system of networked devices configured to administer operation of a chatbot, the system including: a client device including at least one device processor, at least one display, at least one device memory including computer-executable device instructions which, when executed by the at least one device processor, cause the client device to: receive, via a frontend, a query; transmit, to an engine, the query; receive, via the engine, a populated response; display, via the client device, the populated response; and a server network in bidirectional communication with the client device, the server network including at least one server processor, at least one server database, at least one server memory including computer-executable server instructions which, when executed by the at least one server processor, cause the server network to: receive, from the frontend, the query; tokenize, via the engine, the query; generate an intent-match likelihood, via the engine, for each of a plurality of supported question intents; classify, via the engine, the query based on the intent-match likelihoods for each of the plurality of supported question intents; evaluate, via the engine, each of the intent-match likelihoods to a confidence threshold; extract, via the engine and a Named Entity Recognition model, one or more entities from the query; determine one or more entity values for each of the one or more entities; query the at least one server database to incorporate intent to the one or more entities and the one or more entity values; populate, via an action server, a response template with the one or more entity values and one or more specifics to form a populated response, wherein the one or more specifics are correlated to the one or more entity values in a database via an entity value ID; store, via a Tracker Store, the query, the one or more entities, the one or more entity values, the one or more specifics, a user identification, a timestamp, and the populated response based on the intent-match likelihoods and the confidence threshold, wherein the user identification corresponds to a user who transmitted the query, and wherein the timestamp corresponds to the frontend's reception of the query; and transmit, to the frontend, the populated response.

In some aspects, the techniques described herein relate to a system, further including an administrator monitor in electronic communication with the Tracker Store, wherein the administrator monitor includes an administrator authentication login, and wherein the administrator monitor is adapted to provide one or more insights derived from the Tracker Store.

In some aspects, the techniques described herein relate to a system, the frontend further including a chat interface, wherein the chat interface includes a textual entry tool and a chat body configured to display the populated response.

In some aspects, the techniques described herein relate to a system, the frontend further including a speech to text entry tool, wherein the client device is configured to capture audio.

In some aspects, the techniques described herein relate to a system, the frontend further including a profile interface, wherein the profile interface is accessible via actuation of one or more hyperlinks in the populated response, and wherein the profile interface is correlated to the one or more entity value, and the profile interface includes one or more of the one or more specifics.

In some aspects, the techniques described herein relate to a system, wherein the Named Entity Recognition model is trained on a training data set including a plurality of chat logs.

In some aspects, the techniques described herein relate to a system, wherein the Named Entity Recognition model is configured to evaluate the query for one or more errors including typos, punctuation errors, and spelling errors.

In some aspects, the techniques described herein relate to a system, wherein a Fuzzy matcher is configured to filter the one or more entities and the one or more entity values in view of a predetermined geographical region.

In some aspects, the techniques described herein relate to a system, the computer-executable server instructions which, when executed by the at least one server processor, cause the server network to generate an image on the network server, wherein the image is passed through to the populated response.

For the purpose of this disclosure, “one or more entities” or “one or more entity values” may refer to those entities or values present in a query and/or extracted from said query, while “one or more prestored entities” or “one or more prestored entity values” may refer to those entities or values present in the tracker 310 store or other database feature of the system. Thus, as demonstrated herein, as a non-limiting example, the “one or more entities” may be extracted from a query based on the chatbot's ability to review, recall, or identify said “one or more entities” within the “one or more prestored entities.”

These and other aspects, features, and advantages of the present invention will become more readily apparent from the following drawings and the detailed description of the preferred embodiments.

The workflow described herein may be executed and/or used in connection with any suitable machine learning, artificial intelligence, and/or neural network methods. For example, the machine learning models may be one or more classifier and/or neural network. However, any types of models may be utilized, including regression models, reinforcement learning models, vector machines, clustering models, decision trees, random forest models, Bayesian models, and/or Gaussian mixture models. In addition to machine learning models, any suitable statistical models and/or rule-based models may be used.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the claims.

What is claimed is:

1. A system of networked devices configured to administer operation of a chatbot, the system comprising:
a client device comprising at least one device processor, at least one display, at least one device memory comprising computer-executable device instructions which, when executed by the at least one device processor, cause the client device to:
receive, via a frontend, a query;
transmit, to an engine, the query;
receive, via the engine, a populated response;
display, via the client device, the populated response; and
a server network in bidirectional communication with the client device, the server network comprising at least one server processor, at least one server database, at least one server memory comprising computer-executable server instructions which, when executed by the at least one server processor, cause the server network to:
receive, from the frontend, the query;
tokenize, via the engine, the query;
generate an intent-match likelihood, via the engine, for each of a plurality of supported question intents;
classify, via the engine, the query based on the intent-match likelihoods for each of the plurality of supported question intents;
evaluate, via the engine, each of the intent-match likelihoods to a confidence threshold;
extract, via the engine and a Named Entity Recognition model, one or more entities from the query based on one or more prestored entities;
determine one or more entity values for each of the one or more entities;
query the at least one server database to incorporate intent to the one or more entities and the one or more entity values;
populate, via an action server, a response template with the one or more entity values and one or more specifics to form a populated response,
wherein the one or more specifics are correlated to the one or more entity values in the at least one server database via an entity value ID;
store, via a tracker store, the query, the one or more entities, the one or more entity values, the one or more specifics, a user identification, a timestamp, and the populated response based on the intent-match likelihoods and the confidence threshold,
wherein the user identification corresponds to a user who transmitted the query, and
wherein the timestamp corresponds to the frontend's reception of the query; and
transmit, to the frontend, the populated response.

2. The system of networked devices of claim 1, further comprising an administrator monitor in electronic communication with the tracker store, wherein the administrator monitor comprises an administrator authentication login, and wherein the administrator monitor is adapted to provide one or more insights derived from the tracker store.

3. The system of networked devices of claim 1, the frontend further comprising a chat interface, wherein the chat interface comprises a textual entry tool and a chat body configured to display the populated response.

4. The system of networked devices of claim 1, the frontend further comprising a speech to text entry tool, wherein the client device is configured to capture audio.

5. The system of networked devices of claim 1, the frontend further comprising a profile interface, wherein the profile interface is accessible via actuation of one or more hyperlinks in the populated response, and wherein the profile interface is correlated to the one or more entity values, and the profile interface comprises one or more of the one or more specifics.

6. The system of networked devices of claim 1, wherein the Named Entity Recognition model is trained on a training data set comprising a plurality of chat logs.

7. The system of networked devices of claim 1, wherein the Named Entity Recognition model is configured to evaluate the query for one or more errors including typos, punctuation errors, and spelling errors.

8. The system of networked devices of claim 1, wherein a Fuzzy matcher is configured to filter the one or more entities and the one or more entity values in view of a predetermined geographical region.

9. The system of networked devices of claim 1, the computer-executable server instructions which, when executed by the at least one server processor, cause the server network to generate an image on the network server, wherein the image is passed through to the populated response.

10. The system of networked devices of claim 1, the computer-executable server instructions which, when executed by the at least one server processor, cause the server network to:
populate the at least one server database with one or more addresses, each of the one or more addresses correlated to at least one of the one or more entity values;
determine which of the one or more entity values are within a boundary box to build a list of nearby entity values, wherein a center of the boundary box is based on the at least one of the one or more entitles; and
rank the list of nearby entity values based on distance to the at least one of the one or more entity values.

11. The system of networked devices of claim 10, the computer-executable server instructions which, when executed by the at least one server processor, cause the server network to:
convert each of the one or more addresses to a geographical coordinate format.

12. The system of networked devices of claim 11, the computer-executable server instructions which, when executed by the at least one server processor, cause the server network to:
generate a nearby entity interface comprising at least the list of nearby entity values.

13. The system of networked devices of claim 12, wherein the nearby entity interface comprises a profile interface button for each of the list of nearby entity values, wherein actuation of the profile interface button generates a profile interface of the nearby entity value.

14. The system of networked devices of claim 1, the computer-executable server instructions which, when executed by the at least one server processor, cause the server network to:
classify a set of image-inducing entity values from the one or more entity values;
classify a first subset and a second subset from the set of image-inducing entity values;
generate, via the action server, a first subset image based on each of the first subset;
generate a first subset image link, via an object-based storage, for the first subset image; and
transmit the first subset image link, from the object-based storage to the frontend, if one of the first subset entity values exists within the query.

15. The system of networked devices of claim 14, the computer-executable server instructions which, when executed by the at least one server processor, cause the server network to:
generate, via the frontend, a second subset image if one of the second subset entity values exists within the query.

16. The system of networked devices of claim 1, the computer-executable server instructions which, when executed by the at least one server processor, cause the server network to:
classify at least each of the one or more prestored entities stored within the tracker store into a first group or a second group;
delete, via a purge module, in the tracker store, at least the one or more entity values correlated with each of the one or more entities in the first group.

17. The system of networked devices of claim 16, wherein the first group further comprises a first subgroup and a second subgroup, wherein the first subgroup is configured to be purged upon a first subgroup frequency, and wherein the second subgroup is configured to be purged upon a second subgroup frequency.

18. The system of networked devices of claim 5, wherein the profile interface comprises a product data table comprising a quantity selection tool and a timeframe selection tool, wherein the quantity selection tool is configured to alter the product data table from a total product metric to a new product metric, and wherein the timeframe selection tool is configured to alter the product data table from a first timeframe to a second timeframe.

19. The system of networked devices of claim 18, wherein the profile interface comprises a payer table comprising a payer selection tool, wherein the payer selection tool is configured to alter the payer table from a first payer category to a second payer category.

20. The system of networked devices of claim 1, the computer-executable server instructions which, when executed by the at least one server processor, cause the server network to:
scrape an external source for one or more publications correlated to at least one of the one or more entity values;
query at least one of the one or more entity values in the query against the one or more publications;
populate an alert template with one or more of the one or more publications correlated to the at least one of the one or more entity values; and
display, via the frontend, a populated alert.

21. A method for operation of a chatbot, the method comprising the steps of:
receiving, via a frontend, a query;
transmitting, to an engine, the query;
receiving, via the engine, a populated response;
displaying, via a client device, the populated response;
receiving, from the frontend, the query;
tokenizing, via the engine, the query;
generating an intent-match likelihood, via the engine, for each of a plurality of supported question intents;
classifying, via the engine, the query based on the intent-match likelihoods for each of the plurality of supported question intents;
evaluating, via the engine, each of the intent-match likelihoods to a confidence threshold;
extracting, via the engine and a Named Entity Recognition model, one or more entities from the query based on one or more prestored entities;
determining one or more entity values for each of the one or more entities;
querying at least one server database to incorporate intent to the one or more entities and the one or more entity values;
populating, via an action server, a response template with the one or more entity values and one or more specifics to form a populated response,
wherein the one or more specifics are correlated to the one or more entity values in the at least one server database via an entity value ID;
storing, via a tracker store, the query, the one or more entities, the one or more entity values, the one or more specifics, a user identification, a timestamp, and the populated response based on the intent-match likelihoods and the confidence threshold,
wherein the user identification corresponds to a user who transmitted the query, and
wherein the timestamp corresponds to the frontend's reception of the query; and
transmitting, to the frontend, the populated response.

22. A non-transitory computer readable medium having instructions stored thereon that, when executed by a processing device, cause the processing device to carry out an operation of chatbot interaction between a server and a client device, the operation comprising:
receiving, via a frontend, a query;
transmitting, to an engine, the query;
receiving, via the engine, a populated response;
displaying, via the client device, the populated response;
receiving, from the frontend, the query;
tokenizing, via the engine, the query;
generating an intent-match likelihood, via the engine, for each of a plurality of supported question intents;
classifying, via the engine, the query based on the intent-match likelihoods for each of the plurality of supported question intents;
evaluating, via the engine, each of the intent-match likelihoods to a confidence threshold;
extracting, via the engine and a Named Entity Recognition model, one or more entities from the query based on one or more prestored entities;
determining one or more entity values for each of the one or more entities;
querying at least one server database to incorporate intent to the one or more entities and the one or more entity values;
populating, via an action server, a response template with the one or more entity values and one or more specifics to form a populated response,
wherein the one or more specifics are correlated to the one or more entity values in the at least one server database via an entity value ID;
storing, via a tracker store, the query, the one or more entities, the one or more entity values, the one or more specifics, a user identification, a timestamp, and the populated response based on the intent-match likelihoods and the confidence threshold,
wherein the user identification corresponds to a user who transmitted the query, and
wherein the timestamp corresponds to the frontend's reception of the query; and
transmitting, to the frontend, the populated response.

23. A system configured to administer operation of a chatbot, the system comprising:
a client device comprising at least one device processor, at least one display, at least one device memory comprising computer-executable device instructions which, when executed by the at least one device processor, cause the client device to:
transmit, to an engine, a query;
receive a populated response;
display, via the client device, the populated response; and
a server network in bidirectional communication with the client device, the server network comprising at least one server processor, at least one server database, at least one server memory comprising computer-executable server instructions which, when executed by the at least one server processor, cause the server network to:
receive the query;
generate an intent-match likelihood, via the engine, for each of a plurality of supported question intents;
classify, via the engine, the query based on the intent-match likelihoods for each of the plurality of supported question intents;
extract, via a Named Entity Recognition model, one or more entities from the query based on one or more prestored entities;
determine one or more entity values for each of the one or more entities;
query the at least one server database to incorporate intent to the one or more entities and the one or more entity values;
populate a response template with the one or more entity values and one or more specifics to form a populated response,
wherein the one or more specifics are correlated to the one or more entity values in the at least one server database;
store, via a tracker store, the query, the one or more entities, the one or more entity values, the one or more specifics, and the populated response based on the intent-match likelihoods; and
transmit, to the client device, the populated response.
